(19) United States
(12) Patent Application Publication
(10) Pub. No.: US 2016/0023213 A1
(43) Pub. Date: Jan. 28, 2016

(54) MULTI-CHANNEL PIPETTE TOOLS

(71) Applicant: Accel Biotech, Inc., Los Gatos, CA (US)

(72) Inventor: Bruce J. Richardson, Los Gatos, CA (US)

(73) Assignee: Accel Biotech, Inc., Los Gatos, CA (US)

(21) Appl. No.: 14/808,281

(22) Filed: Jul. 24, 2015

Related U.S. Application Data
(60) Provisional application No. 62/028,721, filed on Jul. 24, 2014.
(60) Provisional application No. 62/028,726, filed on Jul. 24, 2014.

(51) Int. Cl. B01L 9/00; B25J 9/02

(52) U.S. Cl. CPC B01L 9/523; B25J 9/023; B01L 2200/18

(57) ABSTRACT

A tool which may be picked up by a dispense head and coupled to a pipette tip coupler. The pipette tip coupler can manipulate gripping arms of the tool using the tip ejection members. A microplate can be transported by this took, the tool parked at a parking location, and the pipette tip coupler used for other uses, such as aspirating or dispensing liquid when pipette tip is coupled onto the pipette tip coupler.

### CROSS REFERENCE TO RELATED APPLICATIONS

The application claims priority from U.S. Provisional Patent Application Ser. No. 62/028,721; filed Jul. 24, 2014 and U.S. Provisional Patent Application Ser. No. 62/028,726; filed Jul. 24, 2014, each of which application is incorporated by reference herein in its entirety for all purposes.

### TECHNICAL FIELD

The technical field of the present disclosure relates to devices and methods for material handling and robotics, and, more particularly, to automated laboratory work station, tools useful for such work stations and related methods, all related to the performance of chemical, biochemical, and molecular assays and reactions.

### BACKGROUND

Automated liquid handling using robotic systems is a technology used for decades in chemical and biochemical fields for reaction preparation and sample processing. Such systems provide a number of advantages, that include high throughput, precision dispensing, labor savings (and attendant cost reduction) and a high degree of repeatability.

One such automated liquid handling system is the AccelBot Mini™ sold by AccelBiotech (Los Gatos, Calif.). This device provides a small footprint system, which is easy to install, self-contained, light weight, yet provides capacity for multiple plates and high precision. A hinged cover included as part of the housing allows both a side and top to be exposed, allowing access during loading or maintenance and allowing a sealed system during sample processing. The system includes an x-axis track onto which is mounted a y-axis arm. Onto y axis arm is mounted a dispensing tool, which may move in the z-axis. The dispensing tool is an eight channel pipetting tool, which may include a means for washing the pipettes. The system has a high speed, repeatability and precision, utilizing a 2-phase stepper motor with microstepping in the drive system. The system is controlled by an external computer, allowing a variety of teaching methods for programming the robotic system, including manual input and automated selection. The device has an external interface (e.g. a USB interface) to allow input and output of signals. Temperature control is also provided as part of the system.

Such a workstation combines into a single programmable system the capabilities for automation of a wide range of bioanalytical procedures including: sample pipetting, serial dilution, reagent additions, mixing, reaction timing, washing of reaction vessels, and incubation that requires sealing of the reaction vessel. The work station may include components to transfer, dispense, and aspirate liquid from one location to another automatically in accordance with user programmed instructions.

In such a workstation, it may be required to cover a sample holding plate or move a sample holding plate. This would require additional tools. Such tools ideally would utilize the already existing means for sample processing, such as the pipettor tool currently included in the workstation.

### SUMMARY

A multi-channel pipette well cover and multi-channel plate transport system is herein disclosed. The well cover and multi-channel plate transport system is configured to work with robotic, automated liquid handling systems comprising an 8-channel pipetting tool for use in various sample processing techniques.

One embodiment comprises a well cover plate comprising a plurality of wells designed to couple with pipette heads of a multi-channel pipetting tool. The wells may comprise a latch mechanism at the top of the wells configured to latch to pipette tips of a multi-channel pipetting tool. The pipette tips may further comprise annular grooves to receive the latch mechanism at the top of the wells on the well cover plate. The latch mechanism may further comprise a ramped feature, which disengages the latch when moved by an ejection bar integral to a pipetting head release component.

Another embodiment comprises a multi-channel plate transport system. The plate transport system comprises a plate gripper, which can be engaged to the pipette heads of a multi-channel pipetting tool. The plate gripper tool may further comprise a bridge structure comprising a plurality of wells, which may be detachably coupled to a plurality of pipette tips on a multi-channel pipetting tool via a latch mechanism. The bridge structure may further comprise a ramped feature, which disengages the latch when moved by an ejection bar integral to a pipetting head release component. The plate gripper tool is configured to open and close using a latch mechanism operable by a pipette head ejection component. The plate gripper tool may be used to pick up and relocate microplates, plate covers, or other components having similar width.

### BRIEF DESCRIPTION OF THE DRAWINGS

FIG. 1 is a front perspective view of a workstation including different tool embodiments.

FIG. 2 is a front perspective view of a workstation in which the plate grabber tool is engaged onto the pipettor tool.

FIG. 3 is a front perspective view of a workstation in which the plate grabber tool is lifting a multi well plate.

FIG. 4 is a front perspective view of a workstation in which the pipettor tool is engaging a plate cover.

FIG. 5 is a front perspective view of a workstation in which the pipettor tool holding a plate cover has moved over a multiwell plate on a plate holding stage.

FIG. 6 is a top perspective view of a plate cover tool.

FIG. 7 is a side view of a pipettor tool holding a plate cover tool.

FIGS. 8, 8a, and 8b are cross sections of the tools of FIG. 7.

FIG. 9 is an isometric view of a pipettor and plate lifting tool.

FIG. 10 is a side view of a pipettor and plate lifting tool.

FIG. 10a is a cross-sectional close-up view of an ejection bar engaging a ramped latch mechanism.

FIG. 10b is a cross-sectional close-up view of a pipette tip engaged with a plate-cover latch.

FIG. 11a is an isometric view of a pipettor and plate grabber tool engaged with a multiwell plate.

FIG. 11b is an isometric view of a plate grabber tool.

FIG. 12 is a bottom view of a plate grabber tool.

FIG. 13a is a front view of a plate grabber tool engaging a multiwell plate.

FIG. 13b is a front perspective view of a plate grabber tool disengaging a multiwell plate.

FIG. 14a1 is a front view of a pipettor tool with a plate grabber tool in the open position.

FIG. 14a2 is a close-up view of the raised edges of a plate grabber tool in the open position.

FIG. 14b1 is a front view of a pipettor tool with a plate grabber tool in the closed position.

FIG. 14b2 is a close-up view of the raised edges of a plate grabber tool in the closed position.

FIG. 15 is a cross-sectional close-up view of an ejection bar engaging a ramped latch mechanism on a plate grabber tool.

FIG. 16a is a cross-sectional close-up view of an ejection bar engaging a ramped latch mechanism on a plate grabber tool.

FIG. 16b is a cross-sectional close-up view of a pipette tip engaged with a plate-cover latch on a plate grabber tool.

### DETAILED DESCRIPTION

The described embodiments may be used with the devices described in U.S. patent application Ser. No. 13/324,640 entitled Three-axis robotic system with linear bearing supports; U.S. Patent Application Ser. No. 13/467,788 entitled Improved Socket Coupling Receptacle; U.S. patent application Ser. No. 14/062,567 Multi-Function Dispense Head; and U.S. patent application Ser. No. 61/881,840. All of these references are hereby expressly incorporated by reference for all purposes herein.

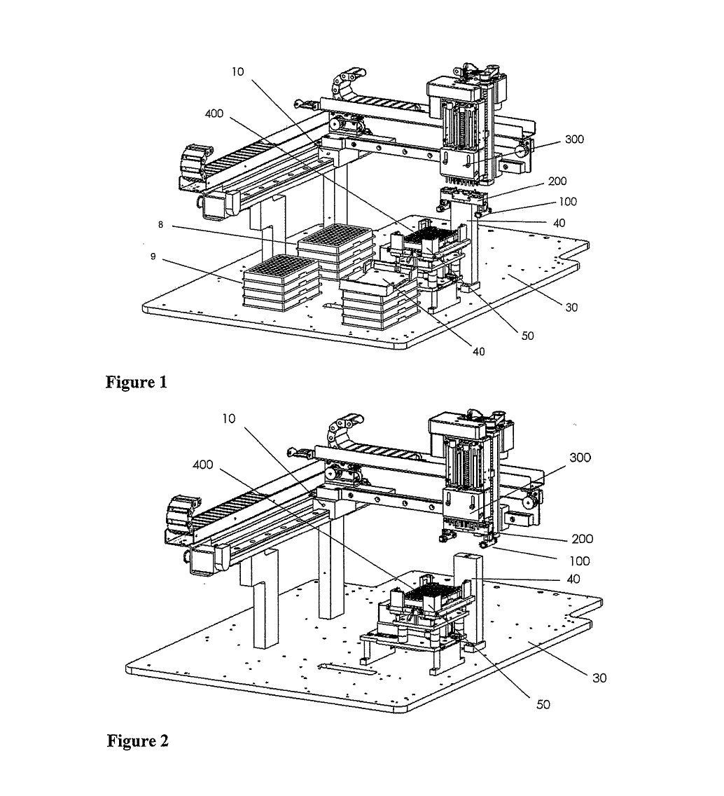

With reference to FIG. 1, the multi-channel pipette head 300 is attached to a multi-axis gantry 10. The multi-axis gantry 10 is used to move the pipette head 300 to various locations on the work surface 30. To move a 96 well microplate 400, the multi-axis gantry 10 couples to the plate gripper tool 200 which can be used to move 96 well microplates (such as sample plate 400, or a plate from new plate stack 9 or used plate stack 8) to various positions on the worksurface 30. Extractable gripper 100 is fixed to the plate gripper tool 200. The multi-channel pipette head 300 attaches to the plate gripper tool 200 using a simple latch mechanism. FIG. 1 shows the retractable gripper 100 on plate gripper tool 200 in the parked location 40.

FIG. 2 shows the multi⁻channel pipette head 300 lifted from parked location 40, latched to the plate gripper tool 200 with retractable gripper 100 ready to be used to pick up a 96 well microplate, 400 from plate park position 50.

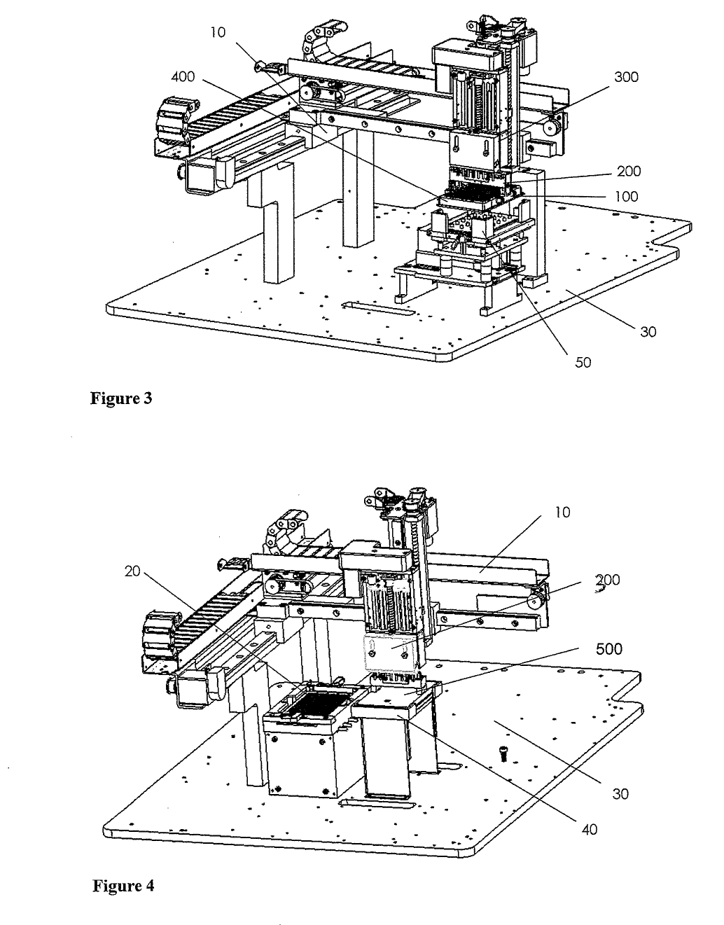

FIG. 3 shows the multi-channel pipette head 300 latched to the plate gripper tool 200 with retractable gripper 100 gripping the sides of a 96 well microplate elevated above the plate park position 50 and moving to a new position on the work surface 30.

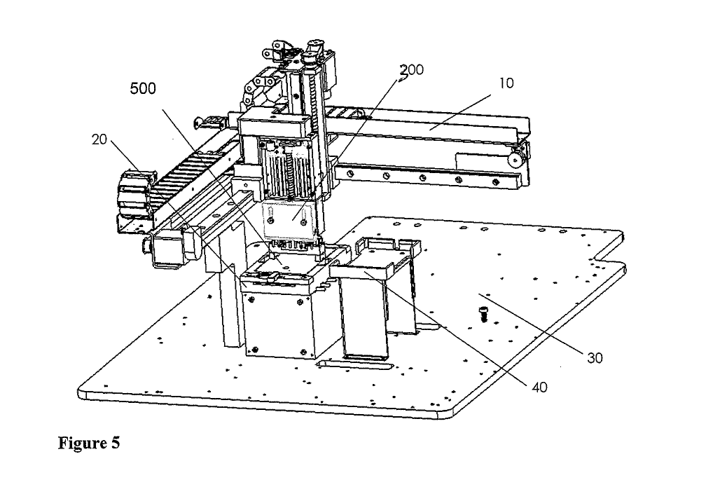

FIG. 4 is a top perspective view showing the movable arm 10 which is used to move the pipette head 300 to couple to the moveable plate cover 100 to seal the 96 well plate 20 located on the work surface 30. Pipette head 300 is shown latched onto the plate cover 500.

FIG. 5 shows the pipette head 300 and the plate cover 500 covering and sealing the 96 well plate 20.

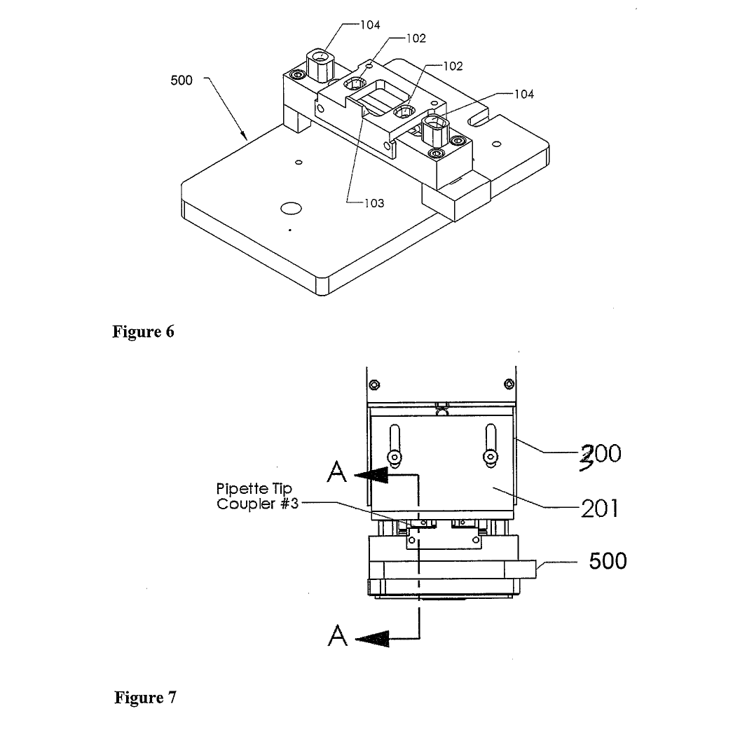

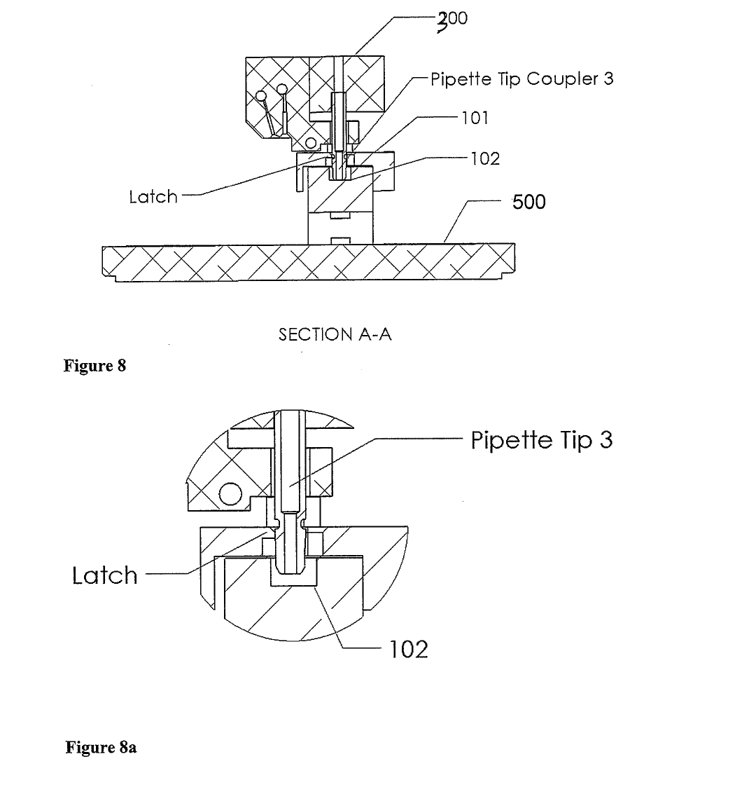

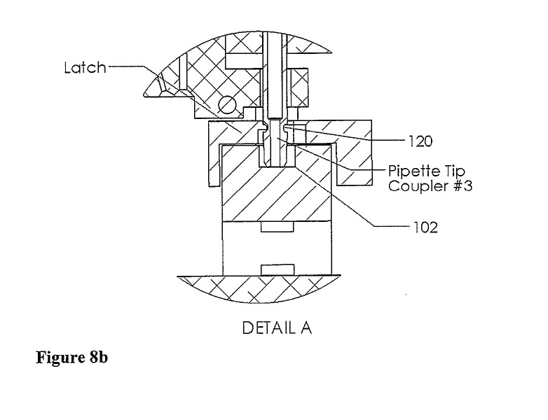

The 8 channel pipette head 300 is configured to pick up the cover assembly using a latch mechanism 101. The latch mechanisms 101 (seen in FIG. 6), located at the top of wells 102, fit into annular grooves 120 in the third and fifth pipette tip couplers of the pipette head 200. (See FIG. 8b) Additional wells 104 help locate the pipette head in the plate cover 100 (See FIG. 6).

The pipette head 300 picks up the plate cover 100 by pressing four of the eight pipette tips firmly into the corresponding wells present on the plate cover 500. A spring loaded latch 101 locks the cover 500 to the pipette head 300 on the third and fifth pipette tip couplers when annular notches in the tips slide into place in wells 102 locked onto spring loaded latch 101, which pivots back to lock onto annular notch 120, as shown in FIG. 8b. FIG. 7 shows the plate cover 500 attached to the pipette head 300. A cross section of the configuration intersecting the third pipette tip is shown in FIGS. 8a and 8b. In FIG. 8a, the latch plate has not yet fit into the notch of the pipette tip coupler. In FIG. 8b, the pipette head 300 is lowered further into the plate cover 500 and the latch can be seen to fit into the groove of the third pipette tip coupler.

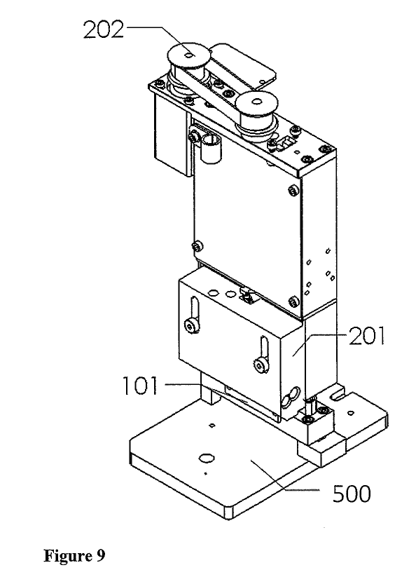

FIG. 9 shows the full assembly of the pipette head 300 coupled with the plate cover 500.

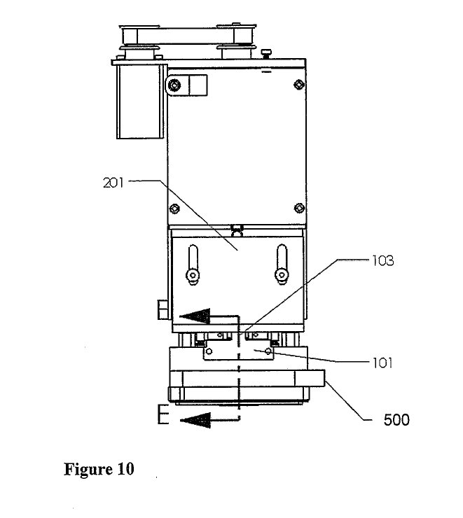

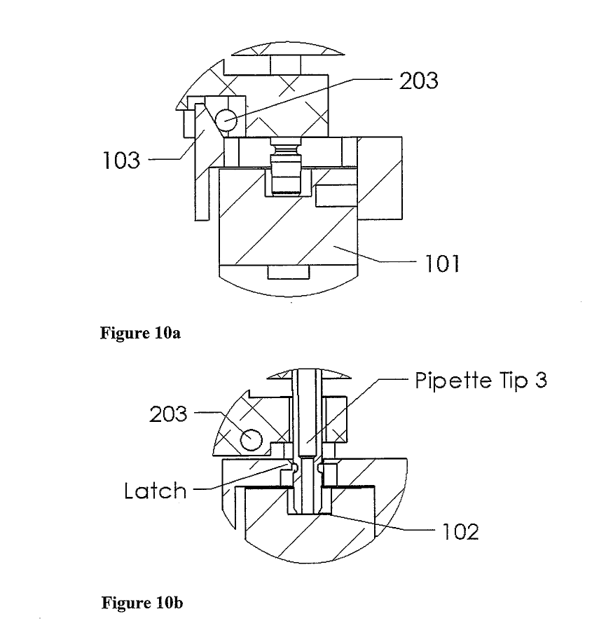

Once the latch in of the latch plate 101 is engaged, as shown above in FIG. 9, the pipette head 300 can be moved to transport the well cover. As pictured in FIG. 9, the pipette tip release component 201 is used to release the plate cover 500. Gear belt 202 moves the ejection component down. In FIG. 9, a bar 203 inside of the tip release component 201 presses on a ramp 103 on the latch plate 107 of the well cover 500. This compresses the spring that maintains the latch compression of latch 101 to the pipette tip and disengages the latch. The well cover 500 can then be released. A cross sectional picture of FIG. 10 taken at the ramp 103 is pictured in FIG. 10a. FIG. 10a shows the ejection bar 203 pressing on the ramp 103. In FIG. 10b, a close-up view of the ejection bar 203 and ramp 103 are shown. FIG. 10b shows the position of latch plate 101 when the ejection bar 203 is pressing on the ramp 103. The latch can be seen to be disengaged from the notch in the pipette tip coupler.

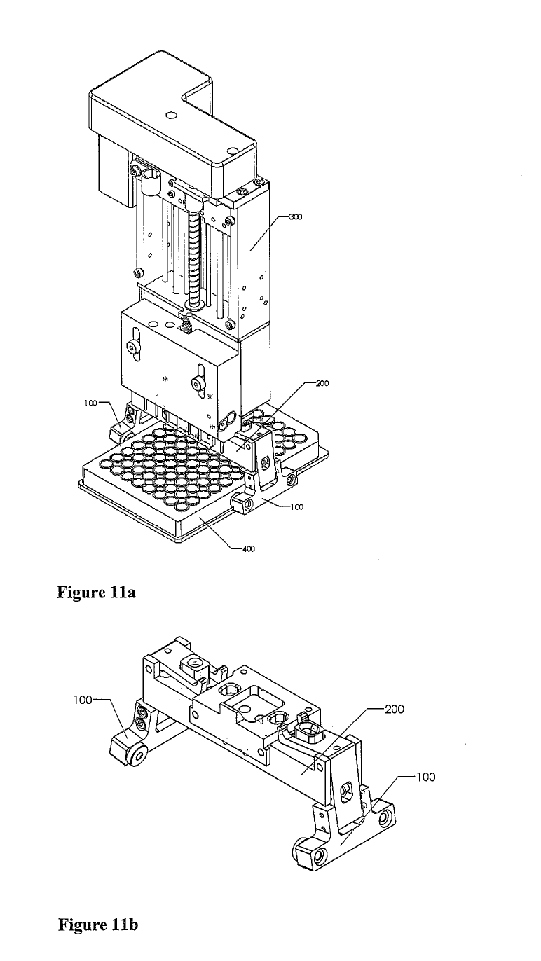

FIG. 11a shows the full pipette head 300 attached to the plate gripping tool 200 with retractable gripper 100. The retractable gripper 100 is attached to the plate gripper tool 200. The multi-channel pipette head 300 attaches to the plate gripper tool 200 using a simple latch mechanism. The ejection plate 301 of the pipette head 300 operates the retractable gripper 100. The gripper is used to pick up microplates, plate covers, or other components having a similar width. The pipette releases the cover and gripper assembly using the tip ejection system 301. In FIG. 11b the plate gripper tool 200 modified with the retractable gripper 100 is pictured.

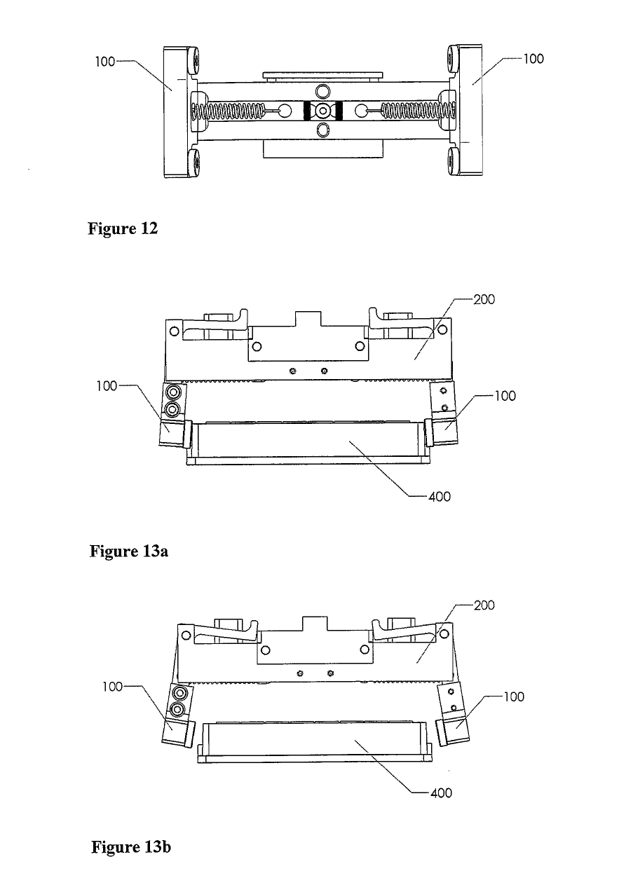

The retractable gripper 100 uses spring compression to maintain pressure on objects. The spring system pictured from the bottom is shown in FIG. 12.

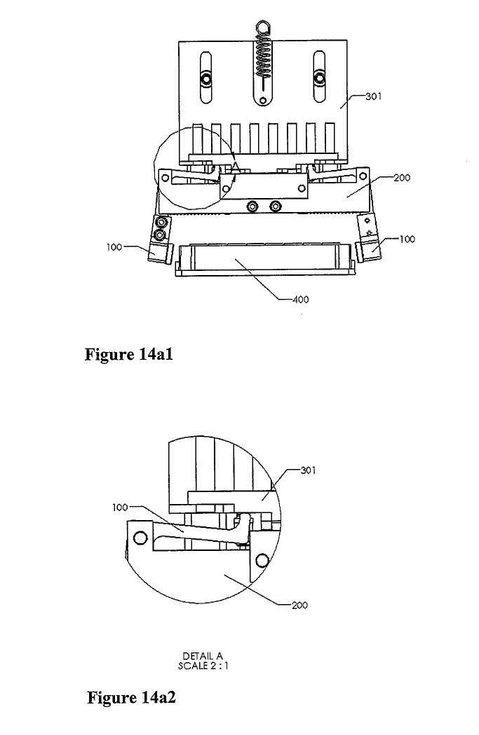

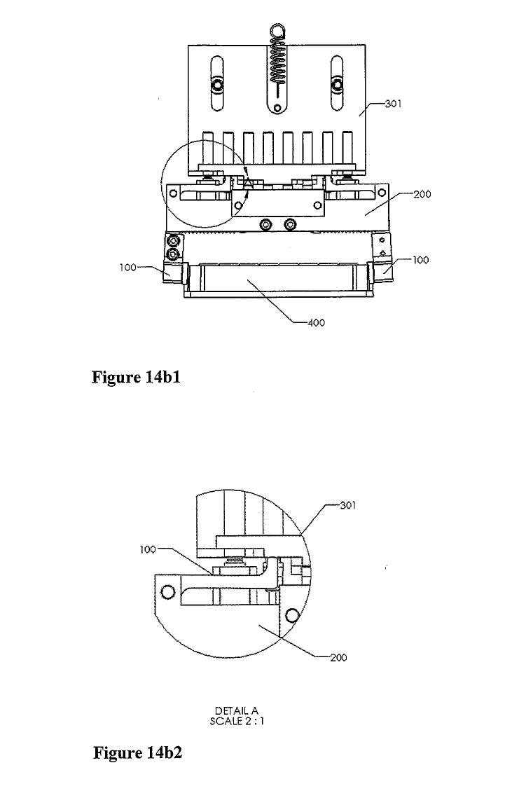

To operate the gripper, the tip release system 301 of the pipette head 300 is utilized. The ejection plate 301 presses down on the raised edges of the retractable gripper 100, causing the gripper to open. When the ejection plate is raised, the plate gripper closes. FIG. 12 shows the retractable gripper 100 in the open and closed positions. FIGS. 13a and 13b show a front perspective view of the raised edges and retractable gripper 100 in the open and closed positions, respectively. FIGS. 14a1 and 14a2 show the retractable gripper 100 in the open configuration with the tip release system 301 in a lowered position to oppose the springs and keep the gripper open. FIGS. 14b1 and 14b2 shows the gripper in the closed position. The tip release system is in the raised position and does not apply pressure to the retractable gripper 100.

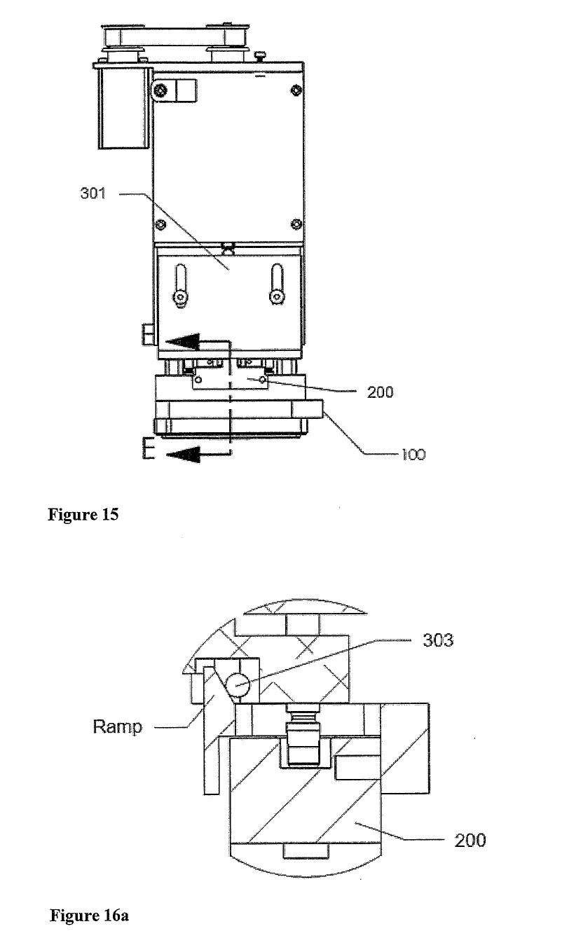

The tip release system 301 can be further lowered to release the entire plate gripper tool 200 and retractable gripper 100. A bar on the tip release system 301 presses on a ramp on the plate gripper tool 200, releasing the latches which hold the cover to the pipette head 300 (see FIG. 15).

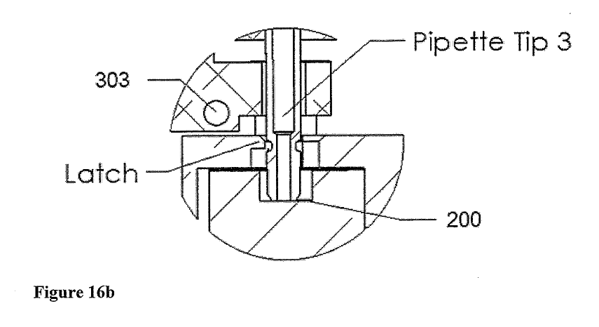

In FIG. 15, the bar 303 inside of the tip release machinery 301 is pressed down on the ramp on the plate gripper tool 200. This compresses the spring that maintains the latch compression of the mechanism to the pipette tip and disengages the latch. The retractable gripper 100 can then be released. A cross-sectional picture of FIG. 15 taken at the ramp is pictured in FIG. 16a. FIG. 16a shows the ejection bar 303 pressing on the ramp at the center of the plate gripper tool 200. In FIG. 16b, a close-up view of the ejection bar 303 and ramp are shown at pipette tip 3. FIG. 16b shows the position of the plate gripper tool 200 in relation to the pipette tip when the ejection bar 303 is pressing on the ramp. The latch can be seen to be disengaged from the notch in the pipette tip coupler.

We claim:

1. A tool used to transport a multi well plate, comprising:
a multi well plate transport tool having two gripping arms spaced to allow retractable gripping of a multiwell plate;
a bridge having a first side end with a first gripping arm secured thereto, and a second side end with a second gripping arm secured thereto;
a plurality of wells on said bridge, said wells dimensioned to allow a pipette tip coupler to be received with said well;
at least two latches, each latch positioned proximate to a top opening of one of said plurality of wells on said bridge, each of said latches mounted such that each latch can be moved back from a surface of said pipette tip coupler and into a latch position in which said latch mates with a groove on said pipette tip coupler; and
a release structure on said bridge, said release structure including an angled surface which may be moved vertically against another surface, wherein such movement against said angled surface creating a pressure on said bridge to cause said at least two latches to unlatch from receiving grooves on said pipette tip couplers.

2. The tool of claim 1, wherein said latches are spring loaded.

3. The tool of claim 1, wherein said groove on the pipette tip coupler is an annular notch.

4. The tool of claim 1, wherein said pipette tip coupler is configured to couple with an 8 channel pipette head.

5. The tool of claim 4, wherein said pipette tip coupler is configured to engage 4 pipette tips on said 8 channel pipette head.
